(19) United States
(12) Patent Application Publication
(10) Pub. No.: US 2025/0086038 A1
(43) Pub. Date: Mar. 13, 2025

(54) PREDICTIVE NETWORK MAINTENANCE

(71) Applicant: SAP SE, Walldorf (DE)

(72) Inventors: Tim Breitenbach, Mitgenfeld (DE); Patrick Jahnke, Leimen (DE)

(21) Appl. No.: 18/466,732

(22) Filed: Sep. 13, 2023

(51) Int. Cl. G06F 11/07; G06F 11/34

(52) U.S. Cl. CPC G06F 11/0754; G06F 11/3452

(57) ABSTRACT

To predict network maintenance, historic records of hardware metrics are obtained for a plurality of network interfaces. An average of the metrics over a specified time span is determined for a plurality of time spans. Feedback metrics are determined for the network interfaces for each of the time spans. A histogram is generated that plots a frequency of the feedback metric for specified ranges of the hardware metric. A threshold value for the hardware metric is determined by iteratively determining whether a hardware metric bin of the histogram meets a specified non-zero value for the feedback metric starting from a highest hardware metric bin of the histogram. Then new records of hardware metrics are obtained and one or more network interfaces are determined to be needing maintenance based on an average of the hardware metrics in the new records meeting or exceeding the determined threshold value for the hardware metric.

### BACKGROUND

The present disclosure relates to computer networking and in particular to predictive maintenance of network components.

Reliable data transfer is important for a fast and efficient data center operation. Transmission, transfer and receiving units are necessary for data transfer. If one of these network components fails, the information sent over the network might not match the received information. Such a failing can happen due to degraded components, which may cause a decrease of sending power, reduced recovered power from the sent signal, or a loss of a signal because of damaged isolator of a cable or a bend in a glass fiber.

Cyclic redundancy checks (CRC) can be used to sense such corrupted information. However, tracking for failures using CRC may only detect a degraded unit after it is already problematic. Furthermore, degraded units that still work but generate CRC errors may not show a permanent faulty behavior. For these reasons using a CRC error rate alone to predict network maintenance is inefficient.

The present disclosure addresses these issue and others, as further described below.

### SUMMARY

The present disclosure provides a computer system. The computer system includes one or more processors and one or more machine-readable medium coupled to the one or more processors. The one or more machine-readable medium store computer program code comprising sets of instructions. The instructions are executable by the one or more processors to obtain historic records of hardware metrics for a plurality of network interfaces in a network. The computer program code further comprising sets of instructions executable to determine an average of the hardware metrics over a specified time span for a plurality of time spans. The computer program code further comprising sets of instructions executable to determine feedback metrics for the plurality of network interfaces for each of the plurality of time spans. The computer program code further comprising sets of instructions executable to generate a histogram plotting a frequency of the feedback metric for specified ranges of the hardware metric, wherein data points used to generate the histogram being a pair including a hardware metric value and a feedback metric value. The computer program code further comprising sets of instructions executable to determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The computer program code further comprising sets of instructions executable to obtain new records of hardware metrics for the plurality of network interfaces. The computer program code further comprising sets of instructions executable to determine that one or more network interfaces of the plurality of network interfaces need maintenance based on an average of the hardware metrics in the new records for the one or more network interfaces over the specified time span meeting or exceeding the determined threshold value for the hardware metric.

The present disclosure provides one or more non-transitory computer-readable medium storing computer program code comprising sets of instructions to obtain historic records of hardware metrics for a plurality of network interfaces in a network. The computer program code further comprises sets of instructions to determine an average of the hardware metrics over a specified time span for a plurality of time spans. The computer program code further comprises sets of instructions to determine feedback metrics for the plurality of network interfaces for each of the plurality of time spans. The computer program code further comprises sets of instructions to generate a histogram plotting a frequency of the feedback metric for specified ranges of the hardware metric, wherein data points used to generate the histogram being a pair including a hardware metric value and a feedback metric value. The computer program code further comprises sets of instructions to determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The computer program code further comprises sets of instructions to obtain new records of hardware metrics for the plurality of network interfaces. The computer program code further comprises sets of instructions to determine that one or more network interfaces of the plurality of network interfaces need maintenance based on an average of the hardware metrics in the new records for the one or more network interfaces over the specified time span meeting or exceeding the determined threshold value for the hardware metric.

The present disclosure provides a computer-implemented method, comprising obtaining historic records of hardware metrics for a plurality of network interfaces in a network. The method further comprises determining an average of the hardware metrics over a specified time span for a plurality of time spans. The method further comprises determining feedback metrics for the plurality of network interfaces for each of the plurality of time spans. The method further comprises generating a histogram plotting a frequency of the feedback metric for specified ranges of the hardware metric, wherein data points used to generate the histogram being a pair including a hardware metric value and a feedback metric value. The method further comprises determining a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The method further comprises obtaining new records of hardware metrics for the plurality of network interfaces. The method further comprises determining that one or more network interfaces of the plurality of network interfaces need maintenance based on an average of the hardware metrics in the new records for the one or more network interfaces over the specified time span meeting or exceeding the determined threshold value for the hardware metric.

The following detailed description and accompanying drawings provide a better understanding of the nature and advantages of the present disclosure.

### BRIEF DESCRIPTION OF THE DRAWINGS

FIG. 1 shows a diagram of a computer system in a data center configured to perform statistical analysis of hardware metrics for predictive maintenance, according to an embodiment.

FIG. 2 shows a flowchart of a computer implemented method for predictive network maintenance based on statistical analysis of hardware metrics, according to an embodiment.

FIG. 3 shows a histogram of the weighted relative frequency of data points with a significant cyclic redundance check error rate by the received power, according to an embodiment.

FIG. 4 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. As used herein, the terms “first,” “second,” “third,” “fourth,” etc., do not necessarily indicate an ordering or sequence unless indicated and may instead be used for differentiation between different objects or elements.

As mentioned above, reliable data transfer is important for a fast and efficient data center operation. Transmission, transfer and receiving units are necessary for data transfer. If one of these network components fails, the information sent over the network might not match the received information. Such a failing can happen due to degraded components, which may cause a decrease of sending power, reduced recovered power from the sent signal, or a loss of a signal because of damaged isolator of a cable or a bend in a glass fiber.

As an example, cyclic redundancy checks (CRC) can be used to sense such corrupted information. However, tracking for failures using CRC may only detect a degraded unit after it is already problematic. Furthermore, degraded units that still work but generate CRC errors may not show a permanent faulty behavior. For these reasons using a CRC error rate alone, or another feedback metric, to predict network maintenance may be inefficient.

Instead of only tracking feedback metrics such as CRC errors, hardware metrics of the network components, such as received power, may be tracked as well. The hardware metrics can be used to find thresholds of reduction in transmitting power or loss of signal, above which there is a high risk to cause CRC errors. These thresholds can be used to perform predictive maintenance, replacing the units efficiently or become aware of potential danger for performance like a cable that does not have sufficient transmission capabilities. Such a procedure allows network operators to balance costs and quality in a purposeful data driven manner.

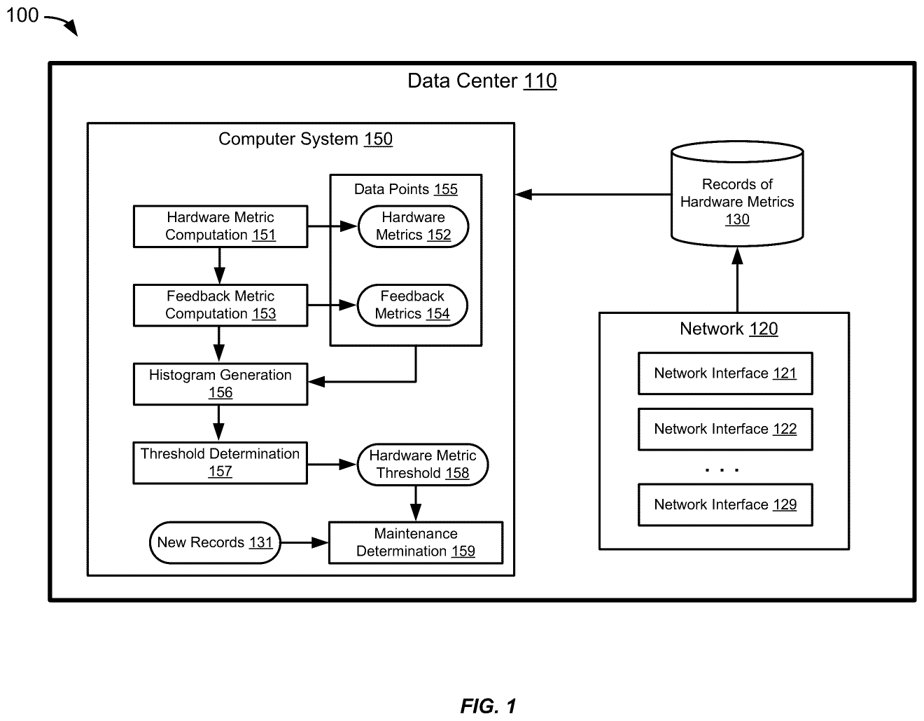

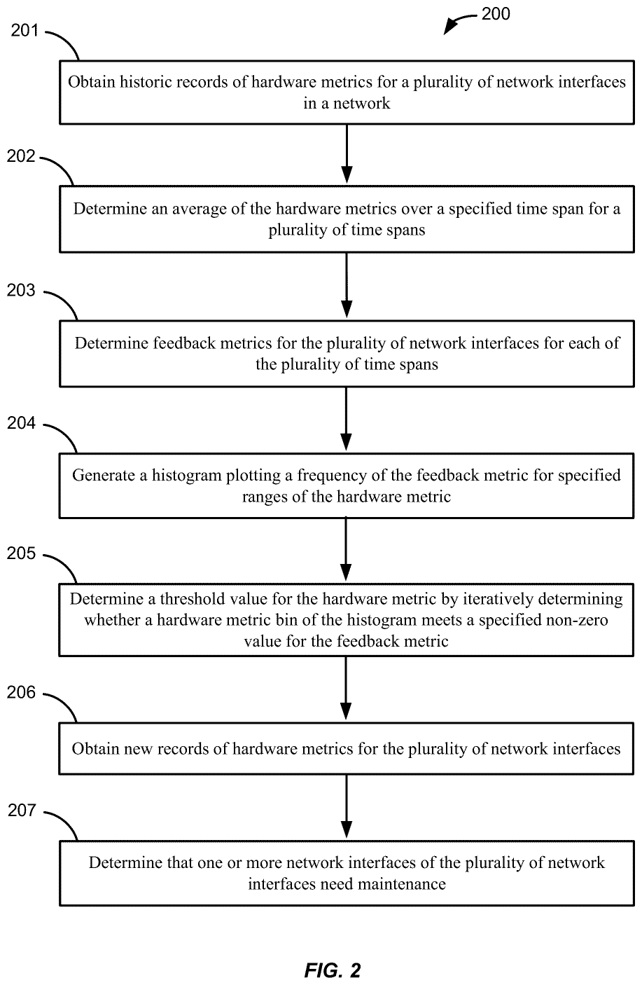

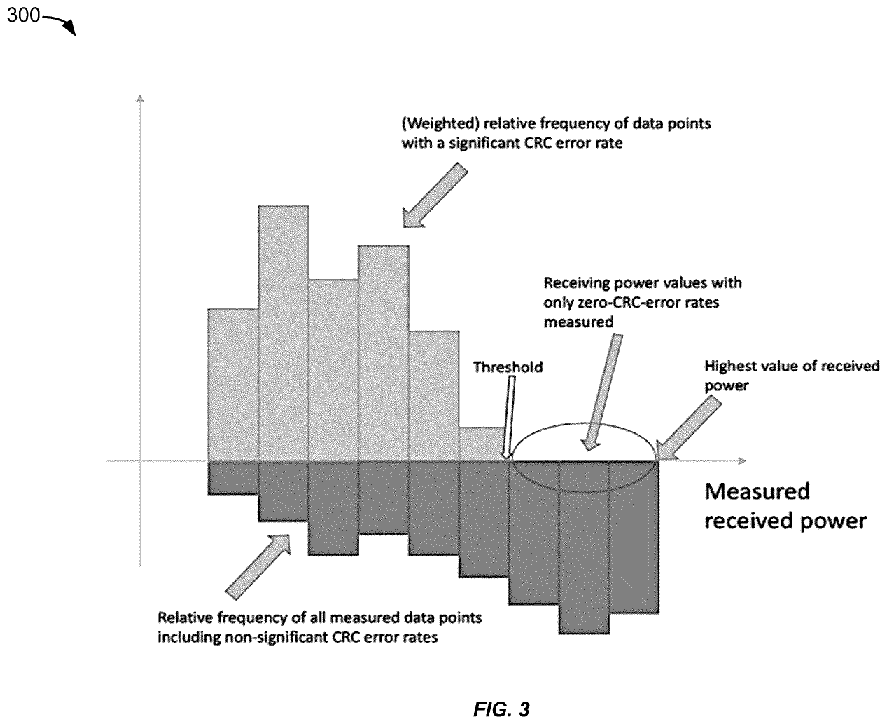

The present disclosure provides techniques for predictive network maintenance using statistical analysis, which enables automated detection of possible sources of risks for failing. FIG. 1 and FIG. 2 provide an overview of systems and methods for performing statistical analysis to determine whether predictive maintenance is needed and FIG. 3 provides an example of a histogram showing a threshold for determining maintenance based on received power.

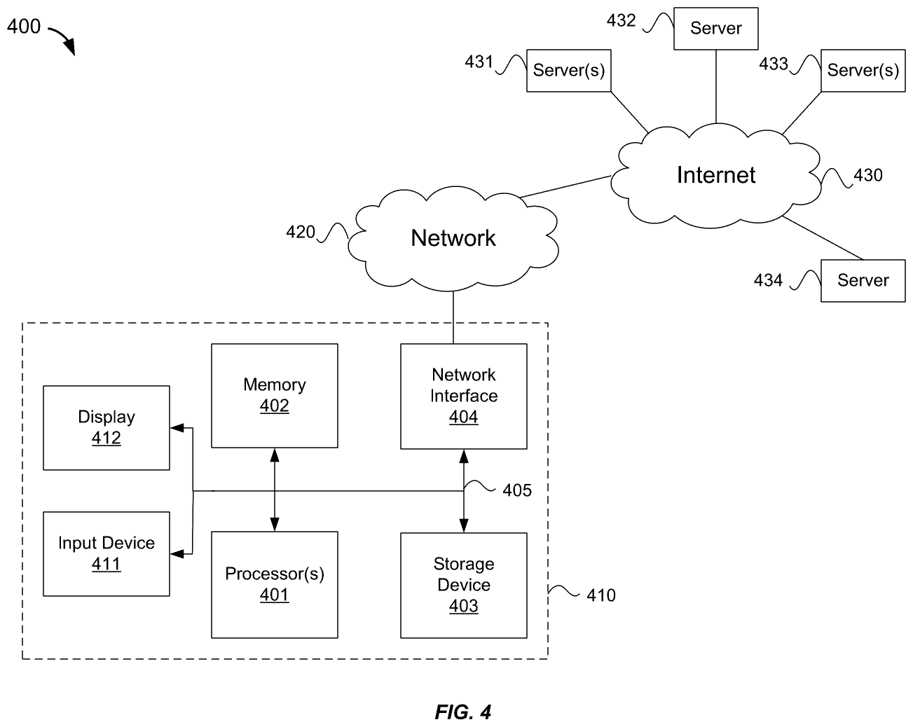

FIG. 1 shows a diagram 100 of a computer system 150 in a data center 110 configured to perform statistical analysis of hardware metrics for predictive maintenance, according to an embodiment. The computer system 150 may be a server computer, for example. The computer system 150 may also include a plurality of computer devices working as a system. The computer system 150 may include computer hardware components such as those described below with respect to FIG. 4. The computer system 150 may be part of a data center 110 providing services to one or more devices, such as database services, over a network 120.

The network 120 includes a plurality of network interface 121, 122, 129. These network interfaces may be optical, copper, or wireless network interfaces, for example. Hardware metrics for each of these network interfaces may be recorded and stored as records of hardware metrics 130. In some embodiments, the hardware metrics are stored together for each of the same class (e.g., the same kind of switches). An example of hardware metrics include transmitted and received power.

The computer system 150 is configured to determine whether the network interfaces 121, 122, 129 need maintenance using statistical analysis. To do this, the computer system 150 includes several software components including a hardware metric computation component 151, a feedback metric computation component 153, a histogram generation component 156, a threshold determination component 157, and a maintenance determination component 159, which are described in further detail below.

The hardware computation component 151 is configured to obtain the historic records of hardware metrics 130 for the plurality of network interfaces 121-129 in the network 120. The hardware computation component 151 is further configured to determine hardware metric values 152 for a plurality of data points 155 by determining an average of the hardware metrics over a specified time span for a plurality of time spans. Received power is an example of such a hardware metric. In some embodiments the hardware computation component 151 may verify that each hardware metric value for each data point 155 is based on at least a specified number of measurements.

The feedback metric computation component 153 is configured to determine feedback metric values 154 for the plurality of data points 155. The feedback metric values 154 are determined for the plurality of network interfaces in each of the plurality of time spans. As an example, cyclic redundancy check error rate may be used as the feedback metric.

In some embodiments the feedback metric computation component 152 is configured to determine data points where the feedback metric is below a tolerance threshold and drop the data points below the tolerance threshold such that they are not used to generate the histogram.

The histogram generation component 156 is configured to generate a histogram plotting a frequency of the feedback metric 154 for specified ranges of the hardware metric 152, wherein data points 155 used to generate the histogram are a pair including the hardware metric value 152 and the feedback metric value 154.

In some embodiments, hardware metric computation component 151 may be configured to normalize the hardware metrics by a total number of data points and the normalized data points may be used in generating the histogram.

In some embodiments the feedback metric computation component 152 may be configured to multiple each data point 155 with its feedback metric 154 and these values may be used in generating the histogram.

The threshold determination component 157 is configured to determine a threshold value 158 for the hardware metric by iteratively determining whether a hardware metric bin of the histogram meets a specified non-zero value for the feedback metric starting from a highest hardware metric bin of the histogram. The threshold value 158 may be determined to be an upper value of a particular hardware metric bin having the feedback metric that meets or exceeds the specified non-zero value. For example, the threshold value may be a particular received power at which a CRC error rate meets or exceeds a specified error rate.

After the threshold value 158 for the hardware metric is determined using statistical analysis as described above, it may be used to predict or determine whether network interfaces need maintenance. To do this, the computer system 150 may obtain new records 131 of hardware metrics for the plurality of network interfaces.

The maintenance determination component 159 is configured to determine that one or more network interfaces of the plurality of network interfaces 121-129 need maintenance based on an average of the hardware metrics in the new records 131 for the one or more network interfaces over the specified time span meeting or exceeding the determined threshold value 158 for the hardware metric.

In some embodiments the maintenance determination component 159 is configured to determine a difference between hardware metrics for a transmitting network interface and a receiving network interface for each of the new records 131. For example, the power received by a receiving network interface may be compared to the power sent by the sending network interface (with which the receiving interface is connected). In this case, the determination that one or more network interfaces need maintenance may be based on the difference between the hardware metrics for the transmitting network interface and the receiving network interface. This difference indicates whether it is the transmitting network interface or the receiving network interface that needs maintenance. In some cases it may be a connection (e.g., fiber or cable) that needs maintenance.

In some embodiments the computer system may further implement the techniques described below with respect to FIG. 3.

Features and advantages of the techniques for predictive network maintenance using statistical analysis including the ability to predict that a network interface will begin to encounter network issues before the feedback value, such as CRC error rate, begins to appear. Accordingly, the network component maintenance can be automatically scheduled and may be performed before there is an impact on the network.

FIG. 2 shows a flowchart 200 of a computer implemented method for predictive network maintenance based on statistical analysis of hardware metrics, according to an embodiment. This method may be performed by a computer system such as the computer system 150 described above with respect to FIG. 1.

At 201, obtain historic records of hardware metrics for a plurality of network interfaces in a network.

At 202, determine an average of the hardware metrics over a specified time span for a plurality of time spans. In some embodiments, the determining of the average of the hardware metrics comprises verifying that each hardware metric value for each data point is based on at least a specified number of measurements.

At 203, determine feedback metrics for the plurality of network interfaces for each of the plurality of time spans.

In some embodiments, the hardware metrics are received power values and the feedback metrics are cyclic redundancy check error rates.

In some embodiments the method may also determine data points where the feedback metric is below a tolerance threshold and drop the data points below the tolerance threshold such that they are not used to generate the histogram.

At 204, generate a histogram plotting a frequency of the feedback metric for specified ranges of the hardware metric, wherein data points used to generate the histogram being a pair including a hardware metric value and a feedback metric value.

In some embodiments, generating the histogram comprises normalizing the hardware metrics by a total number of data points.

In some embodiments, generating the histogram comprises multiplying each data point with its feedback metric.

At 205, determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value.

At 206, obtain new records of hardware metrics for the plurality of network interfaces; and

At 207, determine that one or more network interfaces of the plurality of network interfaces need maintenance based on an average of the hardware metrics in the new records for the one or more network interfaces over the specified time span meeting or exceeding the determined threshold value for the hardware metric.

In some embodiments, the method may also determine a difference between hardware metrics for a transmitting network interface and a receiving network interface for each of the new records, wherein the determination that one or more network interfaces need maintenance is based on the difference between the hardware metrics for the transmitting network interface and the receiving network interface.

### Example Embodiment

Techniques for predictive network maintenance were described above. Now a specific example based on received power and CRC checks is described.

FIG. 3 shows a histogram 300 of the weighted relative frequency of data points with a significant cyclic redundance check error rate by the received power, according to an embodiment. In the histogram 300, the lower portion of the histogram 300 shows the total number of measurements of received power. The upper portion of the histogram 300 shows the number of CRC errors divided by the corresponding number of measurements (in the lower portion below).

Generation of the histogram 300 is described below along with determination of the threshold as shown in FIG. 3 and use of the threshold in determining maintenance for network components.

In this example, the transmitted and received power are recorded at each connection point (e.g., network interface) of the same class (e.g., same kind of switches). The transmitted and received power are averaged over a specified time span, such as every second, minute, hour, or day.

The records of transmitted and received power may be independent of the number of sent or received bytes. As an example, this may be achieved by recording power only when bytes are sent. It may be important to the statistical analysis that the averaging does not include phases where no bytes are sent with zero power contribution. The CRC error rate per byte is also determined and recorded over the same time spans.

Then, all the data points (e.g., a pair of averaged received power value and CRC error rate over a same time span), where no CRC error was measured (or below some specified tolerable CRC error rate) are dropped.

Next, a distribution over the received power is plotted as a histogram, such as histogram 300, where on the ordinate the number of data points associated with the corresponding received power normalized by the total number of data points used for the plot.

Alternatively, each data point can be weighted by multiplying each data point with its CRC error rate where the normalization has to be done by the corresponding total sum of the weighted number of data points used in the plot.

In addition, it may be verified that each received power value has approximately the same data foundation regarding the number of measurements.

If there is a significant variation and the relevant values are measured sufficiently often (which ensures that we do not just relay on an outlier), multiply the probability for each received power (or interval if the distribution is given by a histogram) with the total number of measurement points (including the measurement points with the zero CRC error rate) divided by the number of data points associated to the value of received power (including the ones having a zero CRC error rate).

To find the relevant threshold for received power where the risk for CRC errors begins, start with the highest received power value and descend to decreasing received power values until the distribution shows a significant non-zero value.

All the received power values between the highest received power value and the threshold may be measured sufficiently often so as to exclude that a higher threshold should have been chosen but was not significant because it was not measured significantly often. Consequently, the sufficient data foundation only has to hold from the highest received power value to the identified threshold. If in between there is some gap in the data foundation, meaning there is a received power value measured not so often compared to the others, a reasonable threshold could be higher and may not seen due to a lack of observations.

To evaluate if a connection is probably faulty and needs maintenance, data points for transmitted and received power are determined with the same procedure as for the analysis for getting the threshold (same time span, average) from the transmitting and receiving unit.

Assuming the data points are generated with the same frequency at each device. Take the difference between the received power value and the threshold. Sum up all the negative differences. The more negative the sum is the higher is the rank for maintenance, e.g., to replace devices or components. Alternatively, the rankings can be according to the most negative difference measured or any other suitable measure.

If the transmitting power value is not close to the received power value (e.g., comparison of mean values), the significant portion of the signal might be lost in the transfer (e.g., cable) or receiving unit.

Accordingly, statistical analysis of hardware metrics such as received power can be used to more efficiently determine when network components need maintenance compared to using feedback metrics such as CRC error rate alone or any metric that accounts the impact of the error events on the performance of the network infrastructure.

### Example Hardware

FIG. 4 shows a diagram 400 of hardware of a special purpose computing machine for implementing systems and methods described herein. The following hardware description is merely one example. It is to be understood that a variety of computers topologies may be used to implement the above described techniques. For instance, the computer system may implement the computer implemented method described.

An example computer system 410 is illustrated in FIG. 4. Computer system 410 includes a bus 405 or other communication mechanism for communicating information, and one or more processor(s) 401 coupled with bus 405 for processing information. Computer system 410 also includes a memory 402 coupled to bus 405 for storing information and instructions to be executed by processor 401, including information and instructions for performing some of the techniques described above, for example. This memory 402 may also be used for storing programs executed by processor(s) 401. Possible implementations of this memory may be, but are not limited to, random access memory (RAM), read only memory (ROM), or both. As such, the memory 402 is a non-transitory computer readable storage medium.

A storage device 403 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 403 may include source code, binary code, or software files for performing the techniques above, for example. Storage device and memory are both examples of non-transitory computer readable storage mediums. For example, the storage device 403 may store computer program code including instructions for implementing the method described above with respect to FIG. 2.

Computer system 410 may be coupled using bus 405 to a display 412 for displaying information to a computer user. An input device 411 such as a keyboard, touchscreen, and/or mouse is coupled to bus 405 for communicating information and command selections from the user to processor 401. The combination of these components allows the user to communicate with the system. In some systems, bus 405 represents multiple specialized buses, for example.

Computer system also includes a network interface 404 coupled with bus 405. Network interface 404 may provide two-way data communication between computer system 410 and a network 420. The network interface 404 may be a wireless or wired connection, for example. Computer system 410 can send and receive information through the network interface 404 across a local area network, an Intranet, a cellular network, or the Internet, for example. In the Internet example, a browser, for example, may access data and features on backend systems that may reside on multiple different hardware servers 431, 432, 433, 434 across the network. The servers 431-434 may be part of a cloud computing environment, for example.

### Example Embodiments

Example embodiments of the techniques for machine learning based pre-submit test section are given below.

Some embodiments provide a computer system, comprising one or more processors and one or more machine-readable medium coupled to the one or more processors. The one or more machine-readable medium storing computer program code comprising sets of instructions executable by the one or more processors to obtain historic records of hardware metrics for a plurality of network interfaces in a network. The computer program code further comprising sets of instructions executable to determine an average of the hardware metrics over a specified time span for a plurality of time spans. The computer program code further comprising sets of instructions executable to determine feedback metrics for the plurality of network interfaces for each of the plurality of time spans. The computer program code further comprising sets of instructions executable to generate a histogram plotting a frequency of the feedback metric for specified ranges of the hardware metric, wherein data points used to generate the histogram being a pair including a hardware metric value and a feedback metric value. The computer program code further comprising sets of instructions executable to determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The computer program code further comprising sets of instructions executable to obtain new records of hardware metrics for the plurality of network interfaces. The computer program code further comprising sets of instructions executable to determine that one or more network interfaces of the plurality of network interfaces need maintenance based on an average of the hardware metrics in the new records for the one or more network interfaces over the specified time span meeting or exceeding the determined threshold value for the hardware metric.

In some embodiments of the computer system, the computer program code further comprises sets of instructions executable by the one or more processors to determine a difference between hardware metrics for a transmitting network interface and a receiving network interface for each of the new records, wherein the determination that one or more network interfaces need maintenance is based on the difference between the hardware metrics for the transmitting network interface and the receiving network interface.

In some embodiments of the computer system, the computer program code further comprises sets of instructions executable by the one or more processors to determine data points where the feedback metric is below a tolerance threshold and to drop the data points below the tolerance threshold such that they are not used to generate the histogram.

In some embodiments of the computer system, the generating of the histogram comprises normalizing the hardware metrics by a total number of data points.

In some embodiments of the computer system, the generating of the histogram comprises multiplying each data point with its feedback metric.

In some embodiments of the computer system, the determining of the average of the hardware metrics comprises verifying that each hardware metric value for each data point is based on at least a specified number of measurements.

In some embodiments of the computer system, the hardware metrics are received power values, and wherein the feedback metrics are cyclic redundancy check error rates or frame check sequence.

Some embodiments provide one or more non-transitory computer-readable medium storing computer program code. The computer program code comprises sets of instructions to obtain historic records of hardware metrics for a plurality of network interfaces in a network. The computer program code further comprises sets of instructions to determine an average of the hardware metrics over a specified time span for a plurality of time spans. The computer program code further comprises sets of instructions to determine feedback metrics for the plurality of network interfaces for each of the plurality of time spans. The computer program code further comprises sets of instructions to generate a histogram plotting a frequency of the feedback metric for specified ranges of the hardware metric, wherein data points used to generate the histogram being a pair including a hardware metric value and a feedback metric value. The computer program code further comprises sets of instructions to determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The computer program code further comprises sets of instructions to obtain new records of hardware metrics for the plurality of network interfaces. The computer program code further comprises sets of instructions to determine that one or more network interfaces of the plurality of network interfaces need maintenance based on an average of the hardware metrics in the new records for the one or more network interfaces over the specified time span meeting or exceeding the determined threshold value for the hardware metric.

In some embodiments of the non-transitory computer-readable medium, the computer program code further comprises sets of instructions to determine a difference between hardware metrics for a transmitting network interface and a receiving network interface for each of the new records, wherein the determination that one or more network interfaces need maintenance is based on the difference between the hardware metrics for the transmitting network interface and the receiving network interface.

In some embodiments of the non-transitory computer-readable medium, the computer program code further comprises sets of instructions to determine data points where the feedback metric is below a tolerance threshold and to drop the data points below the tolerance threshold such that they are not used to generate the histogram.

In some embodiments of the non-transitory computer-readable medium, generating the histogram comprises normalizing the hardware metrics by a total number of data points.

In some embodiments of the non-transitory computer-readable medium, generating the histogram comprises multiplying each data point with its feedback metric.

In some embodiments of the non-transitory computer-readable medium, the determining of the average of the hardware metrics comprises verifying that each hardware metric value for each data point is based on at least a specified number of measurements.

In some embodiments of the non-transitory computer-readable medium, the hardware metrics are received power values, and the feedback metrics are cyclic redundancy check error rates.

Some embodiments provide a computer-implemented method. The method comprises obtaining historic records of hardware metrics for a plurality of network interfaces in a network. The method further comprises determining an average of the hardware metrics over a specified time span for a plurality of time spans. The method further comprises determining feedback metrics for the plurality of network interfaces for each of the plurality of time spans. The method further comprises generating a histogram plotting a frequency of the feedback metric for specified ranges of the hardware metric, wherein data points used to generate the histogram being a pair including a hardware metric value and a feedback metric value. The method further comprises determining a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value. The method further comprises obtaining new records of hardware metrics for the plurality of network interfaces. The method further comprises determining that one or more network interfaces of the plurality of network interfaces need maintenance based on an average of the hardware metrics in the new records for the one or more network interfaces over the specified time span meeting or exceeding the determined threshold value for the hardware metric.

In some embodiments of the method, it further comprises determining a difference between hardware metrics for a transmitting network interface and a receiving network interface for each of the new records, wherein the determination that one or more network interfaces need maintenance is based on the difference between the hardware metrics for the transmitting network interface and the receiving network interface.

In some embodiments of the method, it further comprises determining data points where the feedback metric is below a tolerance threshold and dropping the data points below the tolerance threshold such that they are not used to generate the histogram.

In some embodiments of the method, generating the histogram comprises normalizing the hardware metrics by a total number of data points.

In some embodiments of the method, generating the histogram comprises multiplying each data point with its feedback metric.

In some embodiments of the method, the determining of the average of the hardware metrics comprises verifying that each hardware metric value for each data point is based on at least a specified number of measurements.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors; and
one or more machine-readable medium coupled to the one or more processors and storing computer program code comprising sets of instructions executable by the one or more processors to:
obtain historic records of hardware metrics for a plurality of network interfaces in a network;
determine an average of the hardware metrics over a specified time span for a plurality of time spans;
determine feedback metrics for the plurality of network interfaces for each of the plurality of time spans;
generate a histogram plotting a frequency of the feedback metric for specified ranges of the hardware metric, wherein data points used to generate the histogram being a pair including a hardware metric value and a feedback metric value;
determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value;
obtain new records of hardware metrics for the plurality of network interfaces; and
determine that one or more network interfaces of the plurality of network interfaces need maintenance based on an average of the hardware metrics in the new records for the one or more network interfaces over the specified time span meeting or exceeding the determined threshold value for the hardware metric.

2. The computer system of claim 1, wherein the computer program code further comprises sets of instructions executable by the one or more processors to:
determine a difference between hardware metrics for a transmitting network interface and a receiving network interface for each of the new records, wherein the determination that one or more network interfaces need maintenance is based on the difference between the hardware metrics for the transmitting network interface and the receiving network interface.

3. The computer system of claim 1, wherein the computer program code further comprises sets of instructions executable by the one or more processors to:
determine data points where the feedback metric is below a tolerance threshold; and
drop the data points below the tolerance threshold such that they are not used to generate the histogram.

4. The computer system of claim 1, wherein generating the histogram comprises normalizing the hardware metrics by a total number of data points.

5. The computer system of claim 1, wherein generating the histogram comprises multiplying each data point with its feedback metric.

6. The computer system of claim 1, wherein the determining of the average of the hardware metrics comprises verifying that each hardware metric value for each data point is based on at least a specified number of measurements.

7. The computer system of claim 1, wherein the hardware metrics are received power values, and wherein the feedback metrics are cyclic redundancy check error rates.

8. One or more non-transitory computer-readable medium storing computer program code comprising sets of instructions to:
obtain historic records of hardware metrics for a plurality of network interfaces in a network;
determine an average of the hardware metrics over a specified time span for a plurality of time spans;
determine feedback metrics for the plurality of network interfaces for each of the plurality of time spans;
generate a histogram plotting a frequency of the feedback metric for specified ranges of the hardware metric, wherein data points used to generate the histogram being a pair including a hardware metric value and a feedback metric value;
determine a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value;
obtain new records of hardware metrics for the plurality of network interfaces; and
determine that one or more network interfaces of the plurality of network interfaces need maintenance based on an average of the hardware metrics in the new records for the one or more network interfaces over the specified time span meeting or exceeding the determined threshold value for the hardware metric.

9. The non-transitory computer-readable medium of claim 8, wherein the computer program code further comprises sets of instructions to:
determine a difference between hardware metrics for a transmitting network interface and a receiving network interface for each of the new records, wherein the determination that one or more network interfaces need maintenance is based on the difference between the hardware metrics for the transmitting network interface and the receiving network interface.

10. The non-transitory computer-readable medium of claim 8, wherein the computer program code further comprises sets of instructions to:
determine data points where the feedback metric is below a tolerance threshold; and
drop the data points below the tolerance threshold such that they are not used to generate the histogram.

11. The non-transitory computer-readable medium of claim 8, wherein generating the histogram comprises normalizing the hardware metrics by a total number of data points.

12. The non-transitory computer-readable medium of claim 8, wherein generating the histogram comprises multiplying each data point with its feedback metric.

13. The non-transitory computer-readable medium of claim 8, wherein the determining of the average of the hardware metrics comprises verifying that each hardware metric value for each data point is based on at least a specified number of measurements.

14. The non-transitory computer-readable medium of claim 8, wherein the hardware metrics are received power values, and wherein the feedback metrics are cyclic redundancy check error rates or frame check sequences.

15. A computer-implemented method, comprising:
obtaining historic records of hardware metrics for a plurality of network interfaces in a network;
determining an average of the hardware metrics over a specified time span for a plurality of time spans;
determining feedback metrics for the plurality of network interfaces for each of the plurality of time spans;
generating a histogram plotting a frequency of the feedback metric for specified ranges of the hardware metric, wherein data points used to generate the histogram being a pair including a hardware metric value and a feedback metric value;
determining a threshold value for the hardware metric by iteratively determining whether a hardware metric bin of the histogram meets a specified non-zero value for the feedback metric starting from a highest hardware metric bin of the histogram, the threshold value being determined to be an upper value of a particular hardware metric bin having the feedback metric that meets the specified non-zero value;
obtaining new records of hardware metrics for the plurality of network interfaces; and
determining that one or more network interfaces of the plurality of network interfaces need maintenance based on an average of the hardware metrics in the new records for the one or more network interfaces over the specified time span meeting or exceeding the determined threshold value for the hardware metric.

16. The computer-implemented method of claim 15, further comprising:
determining a difference between hardware metrics for a transmitting network interface and a receiving network interface for each of the new records, wherein the determination that one or more network interfaces need maintenance is based on the difference between the hardware metrics for the transmitting network interface and the receiving network interface.

17. The computer-implemented method of claim 15, further comprising:
determining data points where the feedback metric is below a tolerance threshold; and
dropping the data points below the tolerance threshold such that they are not used to generate the histogram.

18. The computer-implemented method of claim 15, wherein generating the histogram comprises normalizing the hardware metrics by a total number of data points.

19. The computer-implemented method of claim 15, wherein generating the histogram comprises multiplying each data point with its feedback metric.

20. The computer-implemented method of claim 15, wherein the determining of the average of the hardware metrics comprises verifying that each hardware metric value for each data point is based on at least a specified number of measurements.
